(19) United States
(12) Patent Application Publication
(10) Pub. No.: US 2007/0091647 A1
(43) Pub. Date: Apr. 26, 2007

(54) Switching power supply unit

(76) Inventors: Hiroshi Takemura, Kyoto-fu (JP); Akio Nishida, Kyoto-fu (JP)

Correspondence Address: MURATA MANUFACTURING COMPANY, LTD.;C/O KEATING & BENNETT, LLP, 8180 GREENSBORO DRIVE, SUITE 850, MCLEAN, VA, 22102, US

(21) Appl. No.: 10/543,957

(22) PCT Filed: Jan. 25, 2005
(86) PCT No.: PCT/JP05/00904

§ 371 Date: Aug. 1, 2005

(30) Foreign Application Priority Data
Nov. 12, 2004 (JP) 2004-329014

(51) Int. Cl. H02M 3/335

(52) U.S. Cl. 363/16

(57) ABSTRACT

A switching power supply unit includes a primary-side rectifying circuit that is connected to a commercial power supply and is arranged to output a primary-side nonsmoothed DC voltage, a transformer having a primary winding and a secondary winding, a switching element connected in series with the primary winding to the output of the primary-side rectifying circuit and arranged to switch the primary-side nonsmoothed DC voltage, a secondary-side rectifying circuit connected to the secondary winding and arranged to output a secondary-side nonsmoothed DC voltage, and an inverter circuit connected to the output of the secondary-side rectifying circuit, and the output is supplied to a gas discharge lamp.

### BACKGROUND OF THE INVENTION

1. Field of the Invention

The present invention relates to a switching power supply unit and more particularly, to a switching power supply unit for power-factor improvement.

2. Description of the Related Art

Regarding an input voltage in general switching power supply units having a DC output and switching power supply units (inverters) having an AC output, it is common to use a DC voltage with a low level of ripples obtained by rectifying a commercial AC power supply voltage using a rectifier diode and by smoothing it using a large-capacitance smoothing capacitor. This method is known as the capacitor input type. In the capacitor input type, since a large-capacitance smoothing capacitor is provided, when a temporary service interruption occurs on the commercial AC power supply side, if the interruption is for a short time, there is a merit in that the reduction in output voltage can be prevented.

However, in general rectifier smoothing circuits of the capacitor input type, there is also a problem in that, since a current flows in the rectifier diode only around the peak time of the AC voltage, the power factor is low as seen from the commercial AC power supply side and a harmonic current is generated on the commercial AC power supply side.

In order to solve this problem, as is disclosed in Japanese Unexamined Patent Application Publication No. 10-150769, a circuit in which a commercial AC voltage, rectified but not smoothed, is directly applied to a primary winding of a transformer and switching is performed and in which the AC voltage obtained in a secondary winding of the transformer is rectified and smoothed is known. By making the waveform of an input current substantially a sine wave, using the circuit allows the improvement of power factor and suppression of harmonic current components to be realized. In this case, after the commercial AC voltage has been rectified, since there is no large-capacitance smoothing capacitor, the size and cost are reduced. Moreover, this is called a capacitor-less converter in the sense that there is no smoothing capacitor included.

In such a capacitor-less converter as disclosed in Japanese Unexamined Patent Application Publication No. 10-150769, after a commercial AC power supply voltage has been rectified, no large-capacitance smoothing capacitor is required. However, after an AC voltage obtained at the secondary winding of the transformer has been rectified, a smoothing capacitor is essential. Moreover, after the commercial AC voltage has been rectified, no smoothing capacitor is provided and accordingly, the voltage obtained by rectifying an AC voltage appearing on the side of the secondary winding of the transformer has very large variation when compared with the case in which a smoothing capacitor is provided on the primary winding side, and a smoothing capacitor having a large capacitance is required in order to make the voltage smooth. Regarding the large-capacitance smoothing capacitor, the larger the capacitance, the larger in size and cost. Accordingly, it is possible to improve power factor and reduce harmonics, but the miniaturization and cost reduction cannot be fully attained.

### SUMMARY OF THE INVENTION

In order to overcome the problems described above, preferred embodiments of the present invention provide a switching power supply unit in which the improvement of power factor and the reduction in harmonics are achieved, full miniaturization and lower cost can be realized, and the efficiency is also high.

In order to achieve the advantages described above, a preferred embodiment of the present invention provides a switching power supply unit including a primary-side rectifying circuit connected to a commercial power supply and arranged to output a primary-side nonsmoothed DC voltage, a transformer having a primary winding and a secondary winding, a switching element connected in series with the primary winding of the transformer to the output of the primary-side rectifying circuit and arranged to switch the primary-side nonsmoothed DC voltage, a secondary-side rectifying circuit connected to the secondary winding of the transformer and arranged to output a secondary-side nonsmoothed DC voltage, and an inverter circuit, the output of which is supplied to a gas discharge lamp, connected to the output of the secondary-side rectifying circuit.

Furthermore, in a switching power supply unit of a preferred embodiment of the present invention, a first rectifier smoothing circuit connected to the secondary winding is also included and a DC output is extracted from the first rectifier smoothing circuit. Moreover, a diode arranged to supply a current to the output side of the first rectifier smoothing circuit is provided between the output of the secondary-side rectifying circuit and the output of the first rectifier smoothing circuit. Moreover, a DC-DC converter circuit is connected to the output of the first rectifier smoothing circuit.

Furthermore, in a switching power supply unit of a preferred embodiment of the present invention, a separate winding included in the transformer and a second rectifier smoothing circuit connected to the separate winding are provided and a DC output is extracted from the second rectifier smoothing circuit. Moreover, the second rectifier smoothing circuit and the secondary-side rectifying circuit have a ground in common, and the diode arranged to supply a current to the output side of the second rectifier smoothing circuit is located between the output of the secondary-side rectifying circuit and the output of the second rectifier smoothing circuit. Moreover, a DC-DC converter circuit is connected to the output of the second rectifier smoothing circuit.

Furthermore, in a switching power supply unit of a preferred embodiment of the present invention, a third rectifier smoothing circuit is connected between both terminals of the switching element, and a DC output is extracted from the third rectifier smoothing circuit. Moreover, an insulated DC-DC converter circuit is connected to the output of the third rectifier smoothing circuit.

In the switching power supply unit according to various preferred embodiments of the present invention, since no large-capacitance smoothing capacitor is required after the rectification of a commercial AC power supply voltage and also no large-capacitance smoothing capacitor is required after the rectification of the AC voltage on the second winding of the transformer, in addition to the improvement of power factor and the suppression of harmonic current, great miniaturization and cost reduction can be achieved. Although the AC output voltage of the inverter more or less varies, since the cycle time of the variation is short, the variation of brightness of a gas discharge lamp driven by the output cannot be perceived and is therefore insignificant.

Furthermore, although the switching power supply unit of preferred embodiments of the present invention is basically an inverter circuit for lighting a gas discharge lamp, also a stable DC voltage can be output by the first rectifier smoothing circuit provided in the secondary winding and by the second rectifier smoothing circuit provided in the separate winding of the transformer. Moreover, when the power supply from the secondary winding and the separate winding temporarily stops due to an instantaneous service interruption, etc., the voltage drop of a DC output can be delayed by receiving a temporary power supply from the input side of the inverter circuit in such a way that a diode arranged to supply a current to the output side of the first and second rectifier smoothing circuits is provided between the output of the secondary-side rectifying circuit and the output of the first and second rectifier smoothing circuits. Furthermore, in addition to the stabilization of the DC output voltage, the voltage drop at a temporary service interruption can be further delayed in such a way that the DC-DC converter circuit having the DC voltage output as an input for outputting a stabilized DC voltage is provided.

Furthermore, the output power of the DC voltage output can be efficiently increased by the third rectifier smoothing circuit disposed between both terminals of the primary-side switching element. Also in this case, the same effect as in the case where the DC-DC converter circuit is disposed on the secondary side can be obtained by the insulation type DC-DC converter circuit included in the output of the third rectifier smoothing circuit.

Moreover, the terms first, second, and third of the above-described rectifier smoothing circuits do not represent a sequence or order of arrangement, but are intended solely for identification purposes. Accordingly, the construction in which the second and third rectifier smoothing circuits are provided without having the first rectifier smoothing circuit can be well considered.

Other features, elements, aspects, characteristics and advantages of the present invention will become more apparent from the following detailed description of preferred embodiments thereof with reference to the attached drawings.

### BRIEF DESCRIPTION OF THE DRAWINGS

FIG. 1 is a circuit diagram of a preferred embodiment of a switching power supply unit of the present invention.

FIG. 2 shows waveforms of a primary-side nonsmoothed DC voltage and a current flowing through the primary winding in the switching power supply unit in FIG. 1.

FIG. 3 shows a waveform of a secondary-side nonsmoothed DC voltage in the switching power supply unit in FIG. 1.

FIG. 4 is the circuit diagram of one example of an inverter circuit in the switching power supply unit in FIG. 1.

FIG. 5 is a circuit diagram of another preferred embodiment of the switching power supply unit of the present invention.

FIG. 6 is a circuit diagram of another preferred embodiment of the switching power supply unit of the present invention.

FIG. 7 is a circuit diagram of another preferred embodiment of the switching power supply unit of the present invention.

FIG. 8 is a circuit diagram of another preferred embodiment of the switching power supply unit of the present invention.

FIG. 9 is a circuit diagram of another preferred embodiment of the switching power supply unit of the present invention.

FIG. 10 is the circuit diagram of another preferred embodiment of the switching power supply unit of the present invention.

### DETAILED DESCRIPTION OF PREFERRED EMBODIMENTS

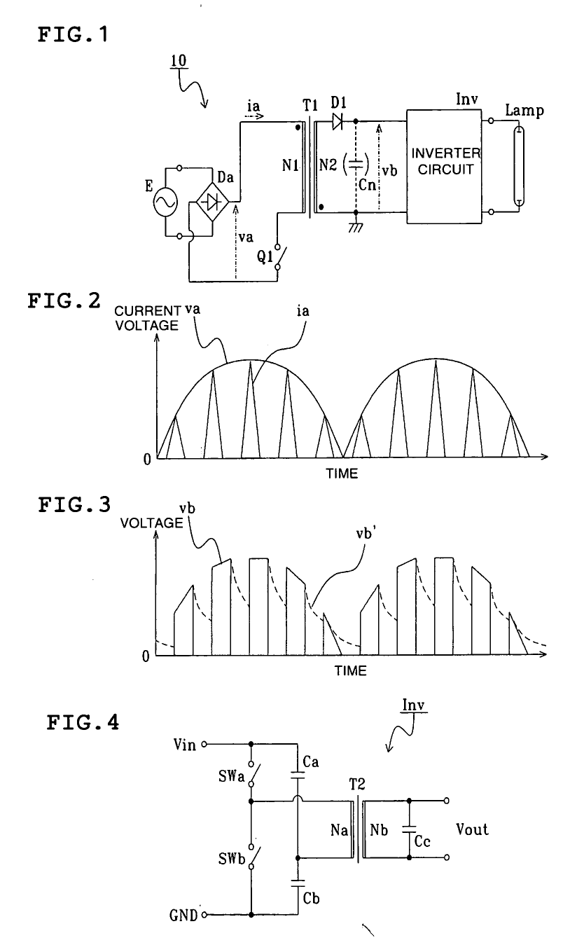

A circuit diagram of a preferred embodiment of a switching power supply unit of the present invention is shown in FIG. 1. In FIG. 1, a switching power supply unit 10 according to a preferred embodiment of the present invention includes a full-wave rectifying circuit Da, a transformer T1 having a primary winding N1 and a secondary winding N2, a switching element Q1, a diode D1, and an inverter circuit Inv.

The input side of the full-wave rectifying circuit Da is connected to a commercial AC power supply E. The primary winding N1 of the transformer T1 and the switching element Q1 are connected in series on the output side of the full-wave rectifying circuit Da. No smoothing capacitor of large capacitance is provided on the output side of the full-wave rectifying circuit Da. The full-wave rectifying circuit Da is a primary rectifying circuit.

One end of the secondary winding N2 of the transformer T1 is connected to the anode of the diode D1 and the other end is connected to a ground on the secondary side. The cathode of the diode D1 is connected to the input terminal of the inverter circuit Inv. The output terminal of the inverter circuit Inv is connected to one end of a gas discharge lamp Lamp. The gas discharge lamp Lamp is, for example, a cold-cathode lamp used as a light source for the backlight in a liquid crystal television, etc. No smoothing capacitor of large capacitance is provided in the rectified output of the diode D1. The diode D1 is a secondary rectifying circuit.

Moreover, although no large-capacitance smoothing capacitor is provided in the output of the secondary rectifying circuit, a capacitor Cn for reducing noise generated in the switching operation may be provided. Regarding the smoothness of a DC voltage input to an apparatus operated by a DC voltage, it is recognized that the ripple (the difference between peak and valley voltages of variation in a DC voltage divided by the average value of the DC voltage and multiplied by 100) is preferably about 10% or less. Particularly, in the case of low voltage apparatuses, the ripple is required to be about 1% or less. Accordingly, in preferred embodiments of the present invention, in order to leave a margin, the case having a capacitor which makes the ripple about 15% or less is considered to have a smoothing capacitor, but the case having a capacitor which makes the ripple more than about 15% is not considered to have a smoothing capacitor.

Now, in the switching power supply unit 10 constructed in this way, the commercial AC power supply generates, for example, an AC voltage of about 100V and about 50 Hz and the voltage is input to the full-wave rectifying circuit Da. Since no large-capacitance smoothing capacitor is provided on the output side of the full-wave rectifying circuit Da, the output voltage of the primary rectifying circuit of the full-wave rectifier Da becomes a full-wave rectified voltage, that is, a ripple voltage. The ripple voltage is called a primary nonsmoothed DC voltage and expressed by va.

The primary nonsmoothed DC voltage va is applied to a series circuit of the primary winding N1 of the transformer T1 and the switching element Q1. The switching element Q1 is switched at a switching frequency of about 100 kHz, for example, by a control circuit (not illustrated). Since the case of this example is of a flyback type, a current flows in the primary winding N1 and the primary winding N1 is excited when the switching element Q1 is in the on state and a current flows out of the secondary winding N2 because of the excitation energy when the switching element Q1 is in the off state. Moreover, in the switching power supply unit 10, a flyback type is assumed, but a forward type may be also used.

In FIG. 2, the waveform of the primary nonsmoothed DC voltage va and the current ia flowing in the primary winding N1 is shown. Moreover, to make it easy to understand, although the switching frequency of the switching element Q1 is assumed to be ten times as large as the frequency of the commercial AC power supply, practically the switching element Q1 is switched at a considerably high frequency as described above.

As is understood from FIG. 2, in average, a current flows over the whole cycle of a commercial AC power supply voltage by controlling so that the current ia is large when the primary nonsmoothed DC voltage va is large and the current ia is small when the primary nonsmoothed voltage va is small. In this way, the power factor is improved and the harmonic current can be minimized.

The current flowing out of the secondary winding N2 of the transformer T1 is rectified by the diode D1 constituting the secondary rectifying circuit. Since no large-capacitance smoothing capacitor is provided for the rectified output of the diode D1, the output voltage of the secondary rectifying circuit including the diode D1 becomes a ripple voltage. This ripple voltage is called a secondary nonsmoothed DC voltage and expressed by vb in preferred embodiments of the present invention. The maximum amplitude of the secondary nonsmoothed DC voltage vb is determined by the step-up ratio of the transformer T1. The secondary nonsmoothed DC voltage vb is applied to the input terminal of the inverter circuit Inv.

In FIG. 3, the waveform of the secondary nonsmoothed DC voltage vb is shown by a solid line. As is understood from FIG. 3, since no large-capacitance smoothing capacitor is also provided in the output of the secondary rectifying circuit, the secondary nonsmoothed DC voltage vb becomes a ripple voltage. Moreover, when a noise reduction capacitor is provided on the output side of the secondary rectifying circuit, the waveform is made more or less dull by that and becomes like the secondary nonsmoothed DC voltage vb′ shown by a broken line in FIG. 3, for example. Also in this case, although the ripple is large as usual when compared with the case where a smoothing capacitor is provided, a period where the secondary nonsmoothed DC voltage becomes zero can be eliminated.

The circuit diagram of one example of an inverter circuit Inv is shown in FIG. 4. In FIG. 4, the inverter Inv includes a transformer T2 having a primary winding Na and a secondary winding Nb, two switching elements SWa and SWb, two capacitors Ca and Cb, and one resonance capacitor Cc.

In the inverter Inv, one end of the switching elements SWa and SWb which are connected in series is connected to an input terminal Vin and the other end is connected to a ground. Furthermore, one end of the capacitors Ca and Cb which are connected in series is connected to the input terminal Vin and the other end is connected to a ground. That is, a series circuit made up of the switching elements SWa and SWb and a series circuit made up of the capacitors Ca and Cb are connected in parallel and that is connected between the input terminal Vin and a ground.

One end of the primary winding Na of the transformer T2 is connected to the connection point between the two switching elements SWa and SWb and the other end is connected to the connection point between the two capacitors Ca and Cb. One end and the other end of the secondary winding Nb of the transformer T2 constitutes terminals which are connected to a gas discharge lamp.

In the inverter circuit Inv constructed in this way, the secondary nonsmoothed DC voltage vb shown in FIG. 3 is applied to both terminals of the switching elements SWa and SWb connected in series. The switching elements SWa and SWb are repeatedly turned on and off alternately at a switching frequency of about 50 kHz, for example, by a control circuit (not illustrated). Thus, an alternating voltage is applied to the primary winding Na of the transformer T2. Then, a stepped-up alternating voltage of about 1 kV to about 1.5 kV is generated from the secondary winding Nb of the transformer T2 and applied to a gas discharge lamp Lamp. Moreover, the switching frequency of the switching elements SWa and SWb may be the same as and be synchronous to the switching element Q1, or may be different from the switching element Q1.

The amplitude of an alternating voltage applied to the gas discharge lamp Lamp changes in proportion to the voltage applied to the input terminal of the inverter circuit Inv. In preferred embodiments of the present invention, since the secondary nonsmoothed DC voltage is a ripple voltage, the amplitude of an alternating voltage applied to the gas discharge lamp Lamp also changes in proportion to that and the brightness changes. However, since the speed at which the amplitude of an alternating voltage applied to the gas discharge lamp Lamp changes corresponds to twice the switching frequency of the inverter Inv and the frequency of a commercial AC power supply (because full-wave rectification is performed), the change cannot be perceived by the human eye and it seems to be in the on state having constant brightness. Accordingly, when the gas discharge lamp is used for lighting, the change over time of the amplitude of an alternating voltage output from the inverter Inv is not a defect and is not noticeable.

Moreover, when the secondary nonsmoothed DC voltage has a waveform shown by vb in FIG. 3, there is a possibility that the input voltage to the inverter Inv becomes zero and there are cases which are not favorable for the operation of the inverter Inv. In this regard, when, for example, a noise reduction capacitor Cn is provided on the output side of the secondary rectifying circuit, since the ripple of the secondary nonsmoothed DC voltage is about 10% or more as shown by vb′ in FIG. 3, although the output cannot be said to be smooth, the waveform does not become completely zero and can be more favorable.

Moreover, in the switching power supply unit 10, since no large-capacitance capacitor is provided on both primary and secondary sides of the transformer T, when there is a momentary service interruption of a commercial AC power supply, the output voltage of the inverter Inv and the brightness of the gas discharge lamp Lamp are directly affected. However, since the time of an actual service interruption is very short, the change cannot be perceived by the human eye and it seems to be in the on state having constant brightness. Accordingly, when the gas discharge lamp is used for lighting, it is not a major defect that an alternating voltage output from the inverter Inv is momentarily reduced by the momentary service interruption of a commercial AC power supply.

Thus, in the switching power supply unit 10, no large-capacitance smoothing capacitor is required on the output side of the primary rectifying circuit Da and on the output side of the secondary rectifying circuit (diode D1). Therefore, while significant improvement of the power factor and lighting a gas discharge lamp is achieved, the reduction in size and cost can also be achieved.

Moreover, in the switching power supply unit 10, although it is stated that, for example, a noise reduction capacitor may be provided on the output side of the secondary rectifying circuit, a noise reduction capacitor may be provided only on the output side of the primary rectifying circuit and the capacitor may be provided on both sides. Furthermore, a capacitor not only for noise reduction, but also having a capacitance in the range where no smoothing function is performed may be provided on the output sides of the primary rectifying circuit and secondary rectifying circuit.

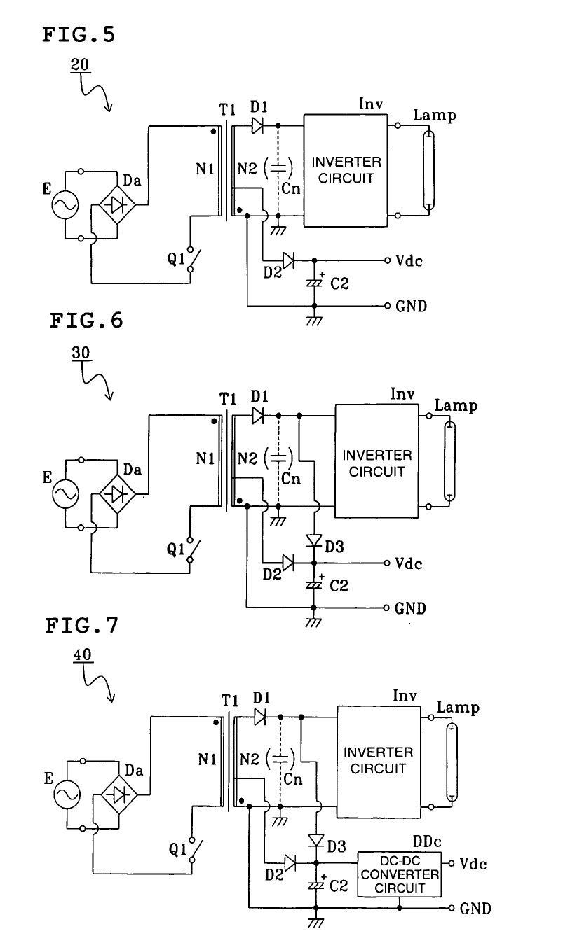

In FIG. 5, a circuit diagram of another preferred embodiment of the switching power supply unit of the present invention is shown. In FIG. 5, the same or equivalent portions as in FIG. 1 are given the same reference numerals and their description is omitted.

In a switching power supply unit 20 shown in FIG. 5, an intermediate tap is provided on the secondary winding N2 of the transformer T1, a rectifier smoothing circuit (first rectifier smoothing circuit) including the rectifier diode D2 and the smoothing capacitor C2 is connected between the intermediate tap and the other end of the secondary winding N2, and a DC voltage is extracted from an output terminal Vdc.

In the switching power supply unit 20 constructed in this way, in addition to lighting of a gas discharge lamp Lamp, a DC voltage can be extracted by making use of an alternating output prepared for producing an input voltage of the inverter Inv prepared for lighting a gas discharge lamp. Generally, in an application using a gas discharge lamp as a backlight as in a liquid crystal television, for example, a DC power supply for driving various other circuits is required. Then, in such a DC power supply, the capability of supplying so much electric power is not required so often. In an application in which a DC power is required except for an alternating voltage for lighting such a gas discharge lamp, the switching power supply unit 20 of preferred embodiments of the present invention has an excellent effect in that another separate DC power supply is not required.

Moreover, in the switching power supply unit 20 shown in FIG. 5, although the first rectifier smoothing circuit is connected to the intermediate tap provided on the secondary winding N2, the intermediate tap is not necessarily required. The first rectifier smoothing circuit including the rectifier diode D2 and the smoothing capacitor C2 may be directly connected to one end of the secondary winding N2, that is, the end portion to which the anode of the diode D1 is connected without including the intermediate tap and then, the same effect can be obtained.

In FIG. 6, a circuit diagram of further another preferred embodiment of the switching power supply unit of the present invention is shown. In FIG. 6, the same or equivalent portions as in FIG. 5 are given the same reference numerals and their description is omitted.

In a switching power supply unit 30 shown in FIG. 6, between the cathode of the diode D1 and the cathode of the diode D2, that is, between the output side of the secondary rectifying circuit and the output side of the first rectifier smoothing circuit, a diode D3 for electric charge movement is disposed so that a current may be supplied from the former to the latter.

Generally, in a power supply where an alternating output for a gas discharge lamp and a DC output for a control circuit, etc., are available, when the gas discharge lamp is in the on state, it is required to maintain the operation of the control circuit so that the control of the gas discharge lamp may not become unstable. When the AC output for the gas discharge lamp and the DC output for the control circuit are obtained from one transformer, both simultaneously stop at the time of service interruption, which is inconvenient. When the diode D3 is provided as described above, it is able to stop the DC output after the AC output has been stopped by supplying the electric charge on the AC output side to the DC output side at the time of service interruption.

In FIG. 7, a circuit diagram of another preferred embodiment of the switching supply unit of the present invention is shown. In FIG. 7, the same or equivalent portions as in FIG. 6 are given the same reference numerals and their description is omitted.

In a switching power supply unit 40 shown in FIG. 7, a DC-DC converter circuit DDc is provided after the first rectifier smoothing circuit including the rectifier diode D2 and the smoothing capacitor C2, and the output is connected to the output terminal Vdc. Here, the DC-DC converter circuit DDc is a general non-insulation type or insulation type DC-DC converter circuit.

Generally, in the DC-DC converter circuit, the output voltage is not reduced until the input voltage becomes a fixed value or less. When the input voltage becomes a fixed value or less, the output voltage is reduced in accordance with that, but, because of the voltage stabilization function of the converter, the output voltage starts to go down behind the input voltage being reduced. That is, there is a more or less time lag therebetween. Therefore, when there is a momentary service interruption in a commercial AC voltage in the switching power supply unit 40, the reduction in the DC output voltage is prevented or further suppressed, and even if an AC output for the gas discharge lamp momentarily stops, the DC output for the control circuit can be made not to stop.

Furthermore, the DC output voltage can be stabilized by the DC-DC converter circuit DDc.

Moreover, although the switching power supply unit 40 in FIG. 7 is constructed in such a way that the DC-DC converter circuit DDc is provided after the rectifier smoothing circuit of the switching power supply unit 30 in FIG. 6, the diode D3 is not essential, and accordingly, the switching power supply unit 40 may be constructed in such a way that the DC-DC converter circuit DDc is provided after the rectifier smoothing circuit of the switching power supply unit 20 in FIG. 5 and then, the same effect can be obtained.

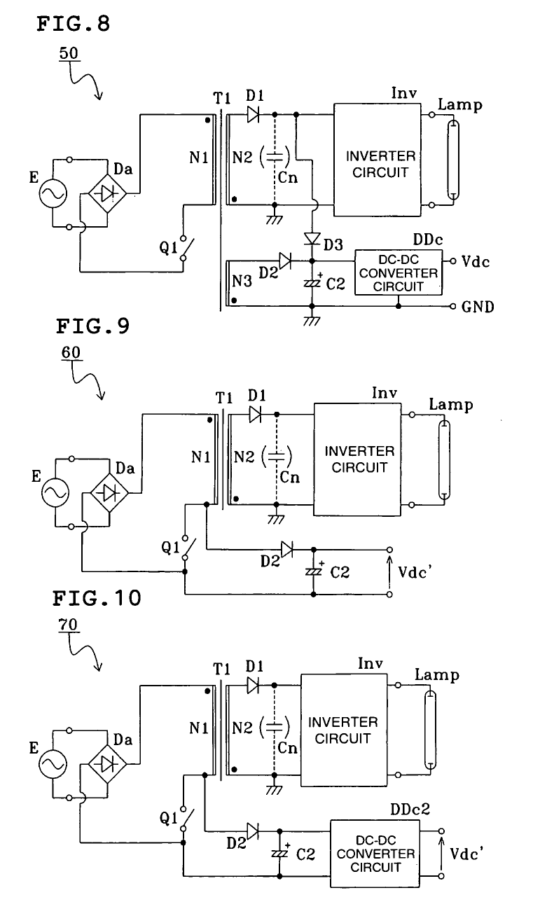

In the switching power supply units 20, 30, and 40 shown in FIGS. 5 to 7, although the rectifier smoothing circuit is separately connected to the secondary winding N2 to which the secondary rectifying circuit is connected, as in a switching power supply unit shown in FIG. 8, a separate winding is provided in the transformer T1 and a rectifier smoothing circuit may be connected to the separate winding to extract a DC output. In a switching power supply unit 50 shown in FIG. 8, a separate winding N3 is provided in the transformer T1 and a rectifier smoothing circuit (second rectifier smoothing circuit) including the rectifier diode D2 and the smoothing capacitor C2 is connected to the separate winding N3, which is the only different point from the switching power supply unit 40 shown in FIG. 7.

In this way, even if the construction in which a rectifier smoothing circuit is connected to a separate winding provided in a transformer to extract a DC output is used, the same effect can be obtained as in the construction in which a rectifier smoothing circuit is connected to a secondary winding to extract a DC output.

Furthermore, although the description is omitted, also with construction in which a DC output is extracted from a separate winding, a construction where no DC-DC converter circuit is provided and a construction where no electric charge movement diode D3 is provided are also practicable. Moreover, a construction including both of a rectifier smoothing circuit (first rectifier smoothing circuit where a DC output is extracted from a secondary winding and a rectifier smoothing circuit (second rectifier smoothing circuit) where a DC output is extracted from a separate winding is provided.

In FIG. 9, a circuit diagram of another preferred embodiment of the switching supply unit of the present invention is shown. In FIG. 9, the same or equivalent portions as in FIG. 1 are given the same reference numerals and their description is omitted.

In a switching power supply unit 60 shown in FIG. 9, a rectifier smoothing circuit (third smoothing circuit) including the rectifier diode D2 and the smoothing capacitor C2 is connected between both terminals of the switching element Q1 and a DC voltage output is extracted from the Vdc′. Moreover, in this case, since the rectifier smoothing circuit is connected on the primary winding side of the transformer T1, the DC voltage output is handled by the primary winding in the same way as the commercial power supply.

In the switching power supply unit 60 constructed in this way, a separate DC power supply can be prepared for the application in which a DC power supply is required except for an AC voltage for lighting a gas discharge lamp in the same way as in the switch supply unit 20 shown in FIG. 5. Moreover, in the case of the switching power supply unit 60, since a DC voltage output as a non-insulation type converter output is obtained from the primary winding side of the transformer T1, a large electric power can be effectively taken out when compared with the switching power supply unit 20, and it can be applied to an application where a DC power supply of relatively large electric power is required except for an AC voltage for lighting a gas discharge lamp.

In FIG. 10, a circuit diagram of another preferred embodiment of the switching supply unit of the present invention is shown. In FIG. 10, the same or equivalent portions as in FIG. 9 are given the same reference numerals and their description is omitted.

In a switching power supply unit 70 shown in FIG. 10, a DC-DC converter circuit DDc2 is provided after the second rectifier smoothing circuit including the rectifier diode D2 and the smoothing capacitor C2, and the output is connected to the output terminal Vdc′. The DC-DC converter circuit DDc2 is an insulation type DC-DC converter circuit using a general transformer. The reason why the insulation type DC-DC converter circuit is used is that, although a general DC voltage output is required to be insulated from a commercial AC power supply, the voltage in the second rectifier smoothing circuit of the switching supply unit 70 is taken out of the primary-side of the transformer T1 and not insulated from the primary side. Furthermore, in addition to that, there is a merit in that the construction of many outputs can be easily used.

Also in the switching power supply unit 70 constructed in this way, in the same way as in the switching supply unit 40 shown in FIG. 7, when there is a momentary service interruption of a commercial AC voltage, the reduction in the DC output voltage can be prevented or more suppressed.

Moreover, in the switching power supply units 60 and 70, although a DC voltage output is obtained by connecting the rectifier smoothing circuit (third rectifier smoothing circuit) only to the primary winding side of the transformer T1, the construction in which another DC voltage output is obtained from the secondary side and the separate winding of the transformer T1 as in the switching power supply units 20, 30, 40, and 50 shown in FIGS. 5 to 8 through the first and second rectifier smoothing circuits may be combined.

The present invention is not limited to each of the preferred embodiments described above. Various changes and modifications may be possible within the scope of the claims. An embodiment obtained by appropriately combining the technical means disclosed in different embodiments is also included in the technological scope of the present invention.

1-9. (canceled)

10. A switching power supply unit comprising:
a primary-side rectifying circuit connected to a commercial power supply and arranged to output a primary-side nonsmoothed DC voltage;
a transformer having a primary winding and a secondary winding;
a switching element connected in series with the primary winding of the transformer to the output of the primary-side rectifying circuit and arranged to switch the primary-side nonsmoothed DC voltage;
a secondary-side rectifying circuit connected to the secondary winding of the transformer and arranged to output a secondary-side nonsmoothed DC voltage; and
an inverter circuit, an output of which is supplied to a gas discharge lamp, connected to the output of the secondary-side rectifying circuit.

11. A switching power supply unit as claimed in claim 10, further comprising a first rectifier smoothing circuit connected to the secondary winding and arranged such that a DC output is extracted from the first rectifier smoothing circuit.

12. A switching power supply unit as claimed in claim 11, further comprising a diode arranged to supply a current to the output side of the first rectifier smoothing circuit between the output of the secondary side rectifying circuit and the output of the first rectifier smoothing circuit.

13. A switching power supply unit as claimed in claim 11, further comprising a DC-DC converter circuit connected to the output of the first rectifier smoothing circuit.

14. A switching power supply unit as claimed in claim 12, further comprising a DC-DC converter circuit connected to the output of the first rectifier smoothing circuit.

15. A switching power supply unit as claimed in claim 10, further comprising a separate winding included in the transformer and a second rectifier smoothing circuit connected to the separate winding and arranged such that a DC output is extracted from the second rectifier smoothing circuit.

16. A switching power supply unit as claimed in claim 15, further comprising the diode arranged to supply a current to the output side of the second rectifier smoothing circuit between the output of the secondary-side rectifying circuit and the output of the second rectifier smoothing circuit and the second rectifier smoothing circuit and the secondary-side rectifying circuit have a ground in common.

17. A switching power supply unit as claimed in claim 15, wherein a DC-DC converter circuit is connected to the output of the second rectifier smoothing circuit.

18. A switching power supply unit as claimed in claim 10, further comprising a third rectifier smoothing circuit connected between both terminals of the switching element and arranged such that a DC output is extracted from the third rectifier smoothing circuit.

19. A switching power supply unit as claimed in claim 18, further comprising an insulated DC-DC converter circuit connected to the output of the third rectifier smoothing circuit.
